(19) United States
(12) Patent Application Publication
(10) Pub. No.: US 2003/0114326 A1
(43) Pub. Date: Jun. 19, 2003

(54) Low Hazardous Air Pollutants blends of naphtha and alcohol useful for removal of paint residues

(76) Inventor: Neil R. Wilson, Lake Orion, MI (US)

Correspondence Address: HENKEL CORPORATION, 2500 RENAISSANCE BLVD, STE 200, GULPH MILLS, PA, 19406, US

(21) Appl. No.: 10/025,729

(22) Filed: Dec. 18, 2001

(51) Int. Cl. C11D 1/00

(52) U.S. Cl. 510/201; 510/505

(57) ABSTRACT

A blend containing about 60 weight percent of aromatic naphtha blends having a TCC flash point of about 100 degrees F, about 25 weight percent of Isopropyl alcohol, and about 15 weight percent of n-butyl acetate as an auxiliary solvents is a low Hazardous Air Pollutants mixture( about 2.7% by weight) with an overall TCC flash point of about 60 degrees F. and an electrical resistivity about 5 Mohms. This blend is low cost and more effective in solvent borne paint residue removal measured by conventional Behr Purge tests than comparative blends.

### CROSS-REFERENCE TO RELATED APPLICATION

Not applicable.

### FIELD OF THE INVENTION

This invention relates to methods and compositions for cleaning uncured paint deposits and residues from equipment employed for painting or pigmenting articles of manufacture following fabricating operations. More specifically, in one aspect, this invention relates to unique methods of preparing blends of solvents useful in cleaning the interior of pipelines, tanks and the like employed in the painting of automobiles, trucks, appliances from unwanted remaining paints and pigments in preparation for the changeover from one paint system to another. In another aspect, this invention relates more specifically to the blended compositions that are prepared according to this invention.

### BACKGROUND OF THE INVENTION

Numerous compositions and blends are available for a wide variety of flushing and cleaning operations to remove uncured paint deposits from tanks and lines. Various mixes and blends of components have been employed for cleaning paint deposits from paint lines and vessels including alkyl acetates, aromatics, ketones, and mono and polyhydric alcohols. U.S. Pat. No. 5,759,975 describes a paint cleaning system which combines a wide range of aromatic solvents and napthas with alcohols and glycolic acids.

Acetates and ketones are optionally employed. U.S. Pat. No. 5,454,985 describes paint stripping compositions comprising water, benzyl alcohols, sulfonates and organic acids.

U.S. Pat. No. 5,035,829 describes paint removing compositions comprising organic carboxylic acids, N-methyl-2-pyrolidone, and an alkylene glycol ether.

While a variety of approaches to blending and resulting blends are known which are satisfactory from either an Hazardous Air Pollutants standpoint, resistivity or low cost, unfortunately none of the current technologies are satisfactory in all such respects.

### BRIEF DESCRIPTION OF THE INVENTION

In accordance with the method of this invention, we blend selected components that result in a cleaning solvent composition of low Hazardous Air Pollutants (HAP) concentration with a TCC Flash Point ( ASTM's Tag Closed Cup method) of about 60 degrees F. or higher, a solvent resistivity of about 0.1 Megaohms (Mohms) or higher and which demonstrates excellent cleaning performance. The composition is relatively low cost to produce.

We prepare the blends of the present invention by selecting and blending together aromatic naphthas having a flash point in excess of about 100 degrees F. with alcohols having a flash point less than about 59 degrees F. so that the resulting blend has a flash point in excess of about 60 degrees F. and a resistivity of 0.1 Mohms or higher. The alcohol-aromatic naptha combination is highly effective in removing solvent borne paint residues while having a flash point above about 100 degrees F. Surprisingly, this combination permits the incorporation of far less relatively expensive auxiliary solvents such as acetates, esters, and ketones while exhibiting superior performance. The preferred blends and methods of the present invention are highly effective for purging residual solvent borne paint systems including pigmented resins of epoxies, polyethers, polyacrylates, polyurethanes, polysesters, melamines and the like.

In general, it is desirable to minimize the content of Hazardous Air Pollutants (HAP) in paint cleaning compositions in an effort to meet Federal Air Pollution Standards as set forth in Section 112 of Title 42 USC 7412 where Hazardous Air Pollutants are listed in Subsection (b). In the formulations of this invention we prefer to maintain HAP content less than about 4.5% as is specified by companies who maintain large paint operations and use these products. However, in general, depending on the application, low HAP mixtures can contain up to about 25% HAP by weight in accordance with the present invention.

While prior art methods such as described in U.S. Pat. No. 5,759,975 employ acidic components such as glycolic and related acidic components to effect a “deep cleaning” of paint encrusted systems, the blends and methods of the present invention are preferably neutral ( neither basic nor acidic) and are designed mainly for purging uncured paint residues from paint lines and vessels. Hence, acids or bases are preferably absent from the formulations. Accordingly, corrosion inhibitors or not required in most applications. Thickeners are preferably not present since they tend to inhibit the flushing operations.

### DETAILED DESCRIPTION OF THE INVENTION

More specifically, in accordance with this invention, we prepare low HAP compositions useful for purging and removal of solvent borne paint residues from paint lines and the like which composition consists essentially of: (1) an aromatic naphtha fraction or blend having a flash point about 100 degrees F. or higher and the naphtha being present from about 40 to about 90% by weight of the total composition, (2) one or more C1 to C5 alcohols having a flash point less than about 59 degrees F. and the alcohol being present from about 10 to about 30% by weight of the total composition, and (3) auxiliary solvents are present from about 1 to about 30% by weight of the total composition. The compositions have an overall flash point of 60 degrees F. or higher and a solvent resistivity of about 0.1 Mohms or higher. Preferably, the compositions are free of acids or bases and have a substantially neutral pH that is most preferably between about 6.5 to about 7.5.

The aromatic naphtha fraction or blends which are useful in the present invention are derived from distillate fractions having a flash point of 100 degrees F. or higher. Alternatively they may be blended mixtures of aromatic hydrocarbons which are mixed to achieve the desired flash point. Typical blends are sold as Aromatic 100 Fluid, SC-100. Aromatic 150 Fluid, SC-150, Naphthalene Depleted Aromatic 150 Fluid, Aromatic 200 Fluid.

The naphtha blend or fraction is more preferably present in the overall paint cleaning composition between about 50 to about 80% by weight and most preferably between about 55 and about 65 by weight of the total. The term flash point as employed herein is as defined in ASTM D 56 Flash Point by Tag Closed Cup Method. More preferably, the naphtha fraction or blend has a flash point between about 100 degrees F. and about 200 degrees F., and most preferably between about 100 and 150 degrees F. Certain substituted aromatics are useful for the naphtha blends including chlorinated or even brominated materials, however, mainly, unsubstituted materials are preferred.

The C 1 to C5 alcohols useful in the paint removal blends of the present invention preferably are monohydric alcohols although polyhydric alcohols including ethylene and propylene glycols are useful as well. Isopropropyl alcohol is most preferred, however, methyl and ethyl alcohols, and branched propyl, butyl and amyl alcohols are useful for preparing the paint cleaners of this invention. In a preferred embodiment, one or more C1 to C5 alcohols having a flash point between about 50 degrees F. and less than about 59 degrees F. are present from about 10 to about 30% by weight of the total composition, and most preferably between about 20 and about 25% by weight of the total composition. Methyl alcohol has a significant effect to lower the resistivity of the resulting blend and if sufficient methyl alcohol is mixed in the blend resistivities below about 1.5 and in the range of about 1.0 may be produced. Hence the use of C2- C5 are preferred to maintain higher electrical resistivity.

We have found, surprisingly, that the selected composition of naphtha and alcohol as set forth above is especially useful in making a low hazardous air pollutants paint cleaner blend meeting automotive specifications for HAP, flash points above about 60 degrees F. and having electrical resistivities above about 0.1 Mohms. Preferably the resistivity of the paint cleaner blend of this invention is about 2 or higher and most preferably above about 4 Mohms. Advantageously, these substantially neutral and low cost blends are quite effective for residual removal of solvent borne paint residues from paint lines while incorporating relatively small percentages of the more expensive or exotic auxiliary solvents such as esters, acetates and ketone solvents .

However, consistent with this invention, a wide range of known auxiliary solvents including methyl isobutyl ketone, methyl ethyl ketone, and the like, as well as butyl and other acetates can be incorporated in the compositions of the present invention. Because of the efficacy of the blends of this invention, such other solvents and other ingredients are present in the total blend between about 1 and about 30% by weight and more preferably between about 5 and about 15% by weight of the total blend.

In the preferred method of purging solvent borne paint residues, the use of conventional added ingredients such as surfactants, thickeners, vapor suppression agents, colorants, corrosion inhibitors or buffers is substantially avoided mainly to avoid compatibility problems. Such materials are added in small amounts, e.g., less than 5% and most preferably less than 2% by weight as needed for other or special applications as may be appropriate.

### EXAMPLES (BLENDS) #'s 1-4

Blend # 1

In this example, we blend 15% n-butyl acetate, 25% isopropropyl alcohol, and 60% of Aromatic 100 Fluid ( an aromatic naphtha having a flash point around 100 degrees F.) to make a total blend having a flash point of 60 degrees F. The resistivity of the overall blend is 5 Mohms and the pH of the blend is about neutral. The HAP content is about 2.7%. All percentages in examples 1-4 are by weight of the total paint cleaner blend. The performance of blends # 1-4 are shown below.

### EXAMPLES 2-4 (COMPARATIVE EXAMPLES)

Blend #2. Flash point of 63 degrees F.

| | |
|---|---|
| Xylene | 55% |
| n-butyl acetate | 10% |
| methyl isobutyl ketone | 30% |
| other solvents | 5% The other solvents include a mixture of |
| | Aromatic 100, isobutyl isobutyrate (IBIB), dibasic |
| | esters (DBE), Aromatic 150, and alcohol based |
| | solvents. |

The HAP concentration of this blend is between 85-90%.
Blend #3 Flash point below 60 degrees F.

| | |
|---|---|
| n-butyl acetate | 70% |
| isopropyl alcohol | 30% |

Blend #4 Flash point below 60 degrees F.

| | |
|---|---|
| n-butyl acetate | 50% |
| isopropyl alcohol | 15% |
| VM&P naphtha | 30% |
| Other solvent | 5% The other solvents include Aromatic 100, |
| | IBIB, DBE, Aromatic 150, alcohol based |
| | solvents, and methyl n-methyl ketone. |

Behr's Purge Efficiency Drop Test

R.D. Specialties wire rod #20 is used to apply 2.0 mils of wet paint to a glass plate. The film was allowed to flash for two minutes before performing the Behr purge method. The glass panel is then placed at a 45 degree angle. Ten drops of purge blend are dispensed from a pipette onto the panel at a drop rate of one drop per second. Each drop contacts the panel at the same point. Panels are rated according to the rating system shown in Table 1.

TABLE 1
Rating System

| Rating # | Description |
|---|---|
| 0 | does not work |
| 1 | not as good as the control |
| 2 | as good as the control or the control |
| 3 | Better/better than the control |
| 4 | Best/far superior than the control |

All paints are BASF Paints

TABLE 2
Performance Ratings at two minute flash time

| Paint | Blend #1 | Blend #2 (control) |
|---|---|---|
| RC 65RW907 Inferno Red | 4 | 2 |
| R126RG091 Tinted Clearcoat | 4 | 2 |
| R165BW905 Patriot Blue | 4 | 2 |
| R126CG2023 Dura clear 3 | 4 | 2 |
| Clearcoat | | |
| R164WW936 Stone White from | 4 | 2 |
| Daimler Chrysler Jefferson | | |
| Assembly Plant | | |
| NLOC21069 Shale Green | 4 | 2 |
| NLOC19935 Stone White | 4 | 2 |
| From Daimler Chrysler | | |
| Toledo Assembly Plant | | |
| U28AW213T Gray Primer | 4 | 2 |
| NLOC19934 | 4 | 2 |

Blends #2-4 are less effective than Blend #1 of this invention and Blend #1 is far less costly to make.

While we described the invention in both general and specific terms, we intend that the invention is limited only by the claims, which appear below:

What is claimed is:

1. A low Hazardous Air Pollutants composition useful for removal of paint residues from pipes and vessels which composition consists essentially of: (1) An aromatic naphtha fraction or blend having a TCC flash point about 100 degrees F. or higher and present from about 40 to about 90% by weight of the total composition, (2) one or more C1 to C5 alcohols having a flash point less than about 59 degrees F. and present from about 10 to about 30% by weight of the total composition, and (3) auxiliary solvent present from about 1 to about 30% by weight of the total composition, said composition having an overall flash point of 60 degrees F. or higher and a solvent resistivity of about 0.1 Mohms or higher.

2. The composition of claim 1 wherein the aromatic naphtha fraction or blend has a flash point between about 100 and about 200 degrees F.

3. The composition of claim 1 wherein said alcohol is a C3 monohydric alcohol.

4. The composition of claim 1 wherein said alcohol is isopropyl alcohol.

5. The composition of claim 1 wherein said alcohol is selected from the group of methyl and ethyl alcohols, and branched or unbranched , propyl, butyl and amyl alcohols.

6. The composition of claim 1 wherein the alcohol is a polyhydric alcohol.

7. The composition of claim 6 wherein the polyhydric alcohol is selected from the group consisting of ethylene and propylene glycols.

8. The composition of claim 1 wherein said auxiliary solvents are selected from esters, ketones and acetates.

9. A low Hazardous Air Pollutants composition useful for purging of solvent borne paint residues which consists essentially of: (1) An aromatic naphtha fraction or blend having a TCC flash point between about 100 and about 150 degrees F. and present from about 50 to about 80% by weight of the total composition, (2) one or more C2 to C5 alcohols having a flash point between about 50 and about 59 degrees F. and present from about 10 to about 30% by weight of the total composition, and (3) auxiliary solvent present from about 5 to about 15% by weight of the total composition, said composition having an overall flash point of 60 degrees F. or higher, a solvent resistivity of about Mohms or higher and a substantially neutral pH.

10. The method of claim 9 wherein said alcohols are present from about 5 to about 15% by weight of the total.

11. A method of removing paint residue which comprises contacting said residue with the composition of claim 1.

12. A method of purging solvent borne paint residue from pipes, vessels and the like which comprises contacting said residue within said pipes, vessels and the like with the composition of claim 9.

13. A method of making a low Hazardous Air Pollutants composition useful for removal of solvent borne paint residues which comprises:
(1) selecting an aromatic naphtha fraction or blend having a flash point above about 100 degrees F.;
(2) selecting one or more C1 to C5 alcohols having a flash point between about 50 to about 59 degrees F.;
(3) blending between about 40 to about 90% by weight of the total composition of said naphtha and between about 10 to about 30% by weight of the total composition of said alcohol and between about 1 and about 30% by weight of the total composition of auxiliary solvents to prepare a composition having a flash point of 60 degrees F. or higher, a resistivity of about 0.15 Mohms or higher and a substantially neutral pH.

14. The method of claim 13 wherein the resistivity of the composition is about 2 Mohms or above.

15. The method of claim 13 wherein the resistivity of the composition is about 4 Mohms or above.

16. A low Hazardous Air Pollutants composition useful for removal of paint residues from pipes and vessels which composition consists essentially of: (1) An aromatic naptha fraction or blend having a TCC flash point between about 100 and about 150 degrees F. and present from about 55 to about 65% by weight of the total composition, (2) isopropyl alcohol having a flash point less than about 59 degrees F. and present from about 15 and about 25% by weight of the total composition, and (3) n-butyl acetate present from about 1 to about 30 % by weight of the total composition, said composition having an overall flash point of 60 degrees F. or higher a solvent resistivity of about 4 Mohms or higher and a substantially neutral pH.

17. The composition of claim 1 wherein the Hazardous Air Pollutants content is about 4.5% by weight or less.
